(19) United States
(12) Patent Application Publication
(10) Pub. No.: US 2011/0165411 A1
(43) Pub. Date: Jul. 7, 2011

(54) PROCESS FOR THE PREPARATION OF A PANEL

(76) Inventors: Johannes Gerardus Hubertus Marie Housmans, Maasbracht (NL); Hubertus Marie Christine Stijnen, Dilsen-Stokkem (BE)

(21) Appl. No.: 12/990,673

(22) PCT Filed: Apr. 29, 2009
(86) PCT No.: PCT/EP2009/055232

§ 371 Date: Jan. 14, 2011

(30) Foreign Application Priority Data
May 7, 2008 (EP) 08155777.9

(51) Int. Cl. B32B 5/16; B29C 43/02; B32B 29/00

(52) U.S. Cl. 428/326; 264/128; 264/122; 428/532; 428/503; 428/506; 428/501

(57) ABSTRACT

The present invention relates to a process for the preparation of a panel comprising ligno-cellulose particles such as a strand-like particles, comprising the steps of treating ligno-cellulose particles at least partially covered with epicuticular wax (2) with ozone (7) at a temperature of at least 30 degrees Celsius, mixing the resulting product with an water-based adhesive resin composition to obtain a resinated particle composition, and pressing and at least partially curing the resinated particle composition to obtain a panel.

The invention relates to a process for the preparation of a panel, in particular for the preparation of a panel comprising ligno-cellulose particles, such as strands. The invention further relates to a panel comprising ligno-cellulose particles. The invention also relates to a floor, a wall or a container comprising the panel according to the invention and to use of such panel in concrete shuttering.

Processes for the preparation of panels from strand-like material are known from for example WO 01/32375. In this process, the bonding of cereal straw in a panel is carried out with urea formaldehyde (UF) resin or melamine urea formaldehyde (MUF) resin in combination with an acid treatment of the straw. It is believed that this treatment alters or removes the wax or lipid layer that surrounds cereal straw. The treatment consists of applying either a strong or weak acid to straw. This results in a drop in straw pH and straw buffering capacity which facilitates the bonding of the straw with UF or MUF in a heated platen press.

The known process has as disadvantage that the treatment of the straw with an acid is rather cumbersome and expensive, and furthermore that the properties of the resulting panel are still unsatisfactory. It is known in the art that, when the acid treatment step is omitted, straw can only be effectively used in a panel in combination with an isocyanate resin. The use of such isocyanate resins for bonding the straw is expensive and special measures have to be taken to prevent the panels from sticking to the press.

It has been tried to use more economic resins to bond ligno-cellulose containing material such as strand-like material such as straw into a panel board. Water-based resins have been tried for that purpose but resulted in very poor quality panels with low mechanical strength.

The terms panel and panel board are used interchangeably herein.

It is one of the objectives of the present invention to reduce or even eliminate the said disadvantages.

This objective is achieved in that the process comprises the step of treating the ligno-cellulose particles with ozone at a temperature of at least 30 degrees Celsius.

The invention may be characterised as follows.

The invention relates to a process for the preparation of a panel comprising ligno-cellulose particles, comprising the following steps:
a) treating ligno-cellulose particles at least partially covered with epicuticular wax with ozone at a temperature of at least 30 degrees Celsius;
b) mixing the resulting product with an water-based adhesive resin composition to obtain a resinated particle composition;
c) pressing and at least partially curing the resinated particle composition obtained in step b) to obtain a panel.

In a preferred embodiment of the process according to the invention, in step a) the ligno-cellulose particles at least partially covered with epicuticular wax are treated with an ozone-containing gas having a temperature of at least 30 degrees Celsius.

In an aspect of the invention the ligno-cellulose particles at least partially covered with epicuticular wax are treated with ozone at a temperature of at least 40 degrees Celsius, preferably an ozone-containing gas having a temperature of at least 40 degrees Celsius.

With particles at least partially covered with epicuticular wax is meant that at least a part of a surface of the particle is covered with epicuticular wax. Preferably at least 5%, more preferably at least 10% of the surface of the particles is covered with epicuticular wax. Typically such particles may be obtained by mechanically cutting, chopping and/or splitting straw covered with epicuticular wax. Examples of straw covered with epicuticular wax include wheat straw, oat straw, rice straw, rye straw and barley straw.

Epicuticular waxes are waxes which cover the plant cuticle (i.e. the plant epidermis) and mainly comprise hydrophobic aliphatic compounds, for instance straight-chain aliphatic hydrocarbons with chain lengths typically in the range of from C16 to C36 and having a variety of substituent groups. Common examples are paraffins, alkyl esters, symmetrical and asymmetrical secondary alcohols like 10-nonacosanol, primary alcohols (mostly octacosan-1-ol), β-diketones, aldehydes and triterpenes. See Baker, E A (1982) Chemistry and morphology of plant epicuticular waxes, in: The Plant Cuticle (eds D J Cutler, K L Alvin, and C E Price), Academic Press, London, pp. 139-165; or Holloway, P J and Jeffree, C E (2005) Epicuticular waxes, in Encyclopedia of Applied Plant Sciences, 3, pp. 1190-1204.

The treatment of ozone may be done by bringing ligno-cellulose particles in contact with ozone. Preferably this is done by providing a flow of ozone-containing gas and contacting the particles at least partially covered with epicuticular wax. A practical way is to place the ligno-cellulose particles at least partially covered with epicuticular wax in a chamber having an ozone inlet and an ozone outlet and thereafter generate a flow of the ozone containing gas in the direction of from the ozone inlet towards the ozone outlet. The temperature of the ozone containing gas being at least 30 degrees Celsius. Preferably the ozone inlet and ozone outlet are located substantially opposite towards each other.

Alternatively a batch of ligno-cellulose particles, preferably straw strands may be placed in a chamber via an opening in the chamber, the chamber may be filled with an ozone-containing gas, thereafter the opening is closed and the chamber is heated to result in the ozone containing gas in the chamber having a temperature of at least 30 degrees Celsius. Heating may be done by means known by the person skilled in the art. The ligno-cellulose particles are kept in an ozone containing atmosphere of at least 30 degrees Celsius for a period of time. To reduce the treatment time the pressure of the ozone-containing gas in the chamber may be increased and/or the temperature may be further elevated.

In an aspect of the process according to the invention the treatment with ozone occurs at a temperature of at least 45, 50, 55 or 60 degrees Celsius. Preferably, this temperature is at least 60 degrees Celsius, such as for example at least 65, 70, 75 or 80 degrees Celsius to reduce the time needed for the ozone treatment. More preferably, the temperature is at least 80 degrees Celsius, such as at least 85, 90, 95 or 100 degrees Celsius. Even more preferably, the temperature is at least 100 degrees Celsius, such as at least 105, 110, 115 or at least 120 degrees Celsius. Even higher temperatures may be advantageously employed for the ozone treatment in the method according to the invention, care should be taken however not to exceed the temperature where straw will disintegrate or burn (flame temperature).

The amount of ozone used in the ozone treatment may vary between limits; the amount has to be sufficient to result in the ligno-cellulose particles being glued together by the water-based adhesive resin composition during pressing of the resinated ligno-cellulose particles to form the panel. In the examples described herein a flow of ozone containing gas was used to treat the ligno-cellulose particles with ozone. An excess amount of ozone based on the wax was used. This was determined by establishing that there still was ozone present at the ozone-outlet indicating not all ozone had been consumed during the treatment. Suitable concentrations of ozone are for example in the range of from 0.1 to 300 gram ozone/m³, preferably in the range of from 0.1 to 200 gram ozone/m³, more preferably in a range of from 1 to 100 gram ozone/m³.

A practical ozone treatment time may be in a range of from 0.1 second to 1 hour. Preferably the ozone treatment time of the particles at least partially covered with epicuticular wax is in the range of from 1 sec. to 10 min., more preferably in the range of from 1 min. to 5 minutes.

The amount of ligno-cellulose particles may be in a range of from 10 gram to 5000 kg, preferably in the range of from 100 gram to 4000 kg, more preferably in the range of from 100 gram to 3000 kg.

The water-based adhesive resin composition as used herein is a composition comprising a water-based resin and having adhesive properties towards ligno-cellulose particles.

Depending on the type of resin used the water-based adhesive resin composition may further comprise for example a catalyst. The resin used may for example be an aminoplast resin. As aminoplast resin are used in the present invention condensation products of an aminocompound with an aldehyde. As aminocompound urea, melamine, melam, melem, ureidemelamine and mixtures thereof can be used. Preferably melamine and/or urea are used. Suitable catalysts to form an adhesive from the aminoplast resin are for example metal salts, preferably salts of sodium, potassium, ammonium, aluminium, magnesium and zinc. Examples of suitable salts are sodium nitrate, aluminium sulphate, ammonium hydrogenphosphate, ammonium persulphate, ammonium chloride, ammonium sulphate and ammonium nitrate. Preferably ammonium salts are used and in particular ammonium chloride or ammonium sulphate.

The water-based adhesive resin composition composition may—as is commonly done—comprise other compound such as for example a filler such as wheat flower or scavengers.

The curing temperature of the resinated particle composition in the process according to the invention may be in the range of from 2 to 252 degrees Celsius. Usually the curing of the resinated particle composition to form a panel takes place at a temperature of from 77 to 252 degrees Celsius. Preferably such curing takes place at a temperature of from 100 to 252 degrees Celsius, more preferably at a temperature of from 202 to 252 degrees Celsius.

In an embodiment of the process according to the invention the ligno-cellulose particles at least partially covered with epicuticular wax comprise Poaceae particles, preferably grass particles.

Poaceae or Gramineae is a family in the Class Liliopsida (the monocots) of the flowering plants. Plants of this family are usually called grasses; the shrub- or tree-like plants in this family are called bamboo. Plant communities dominated by Poaceae are called grasslands. The Poaceae plant family includes the staple food grains, cereal crops, lawn and forage grasses.

Suitable ligno-cellulose particles at least partially covered with epicuticular wax may, for instance, be obtained from Elephant grass, a species name which may refer to any of the following grass species:

The African Pennisetum purpureum (also Napier Grass or King Grass) in the genus Pennisetum;

The southern Asian grass Saccharum ravennae, or Erianthus ravennae, or Erianthus elephantinus;

The Asiatic Zebra grass or Porcupine Grass Miscanthus sinensis.

In an aspect of the process according to the invention the ligno-cellulose particles at least partially covered with epicuticular wax are non-wood agricultural particles.

In an aspect of the process according to the invention the ligno-cellulose particles at least partially covered with epicuticular wax have a water content up to full saturation.

In an aspect of the invention the process according to the invention the ligno-cellulose particles at least partially covered with epicuticular wax comprise, preferably consist of, natural straw.

In an embodiment of the process according to the invention the ligno-cellulose particles at least partially covered with epicuticular wax comprise particles selected from the group consisting of wheat straw particles, oat straw particles, rice straw particles, rye straw particles and barley straw particles and combinations thereof.

In an aspect of the process according to the invention the ligno-cellulose particles at least partially covered with epicuticular wax consist of particles selected from the group consisting of wheat straw particles, oat straw particles, rice straw particles, rye straw particles and barley straw particles and combinations thereof.

In an embodiment of the process according to the invention prior to step b) the ligno-cellulose particles at least partially covered with epicuticular wax are mixed with wood particles.

In an aspect of the process according to the invention the ligno-cellulose particles are mixed with wood particles prior to mixing the resulting product from step a) with the water-based adhesive resin composition to obtain a resinated particle composition. The mixing is preferably done after treating the ligno-cellulose particles with ozone at a temperature of at least 30 degrees Celsius.

In an aspect of the process according to the invention the process is a process for the manufacturing of a panel consisting of ligno-cellulose particles at least partially covered with wax.

In an embodiment of the process according to the invention the water-based adhesive resin composition is selected from the group consisting of soy-based resin, protein based resin, an aldehyde resin, with the aldehyde resin further comprising at least one component selected from the group consisting of urea, phenol, melamine, melem, melam and ureido melamine and mixtures thereof. In practice soy-based resin may be a soybean based resin.

In an aspect of the process according to the invention the water-based adhesive resin composition comprises an aldehyde, melamine and or urea.

The invention also relates to a process as described herein wherein the aldehyde is selected from the group consisting of formaldehyde, glyoxal and acetaldehyde and combinations thereof.

In an aspect of the process according to the invention the water-based adhesive resin composition is present in an amount of between 1 and 30 wt % based on the resinated particle composition.

In an aspect of the process according to the invention the water-based adhesive resin composition is cured to at least 75%.

The particles at least partially covered with epicuticular wax particularly suitable for making Particle Board (PB) in the process according to the invention may preferably have dimensions of 0.1 millimetre to several millimetres, preferably in the order of 1 millimetre.

In an embodiment of the process according to the invention the ligno-cellulose particles at least partially covered with epicuticular wax include ligno-cellulose particles at least partially covered with epicuticular wax having a length of at least 0.3 mm.

Preferably at least 80%, based on the weight, of the ligno-cellulose particles at least partially covered with epicuticular wax have a length of at least 0.3 mm.

The length in the scope of this invention is the length of the longest distance of the particle.

In an embodiment of the process according to the invention the ligno-cellulose particles least partially covered with epicuticular wax include ligno-cellulose particles having a length in the range of from 0.3 mm to 15 mm. The particles having a length in the range of from 0.3 mm to 15 mm are particularly suitable for making particle board.

Preferably at least 80%, based on the weight, of the particles have a length of from 0.3 mm to 15 mm. More preferably at least 95%, based on the weight, of the particles have a length of from 0.3 mm to 15 mm.

Preferably the ligno-cellulose particles having a length in the range of from 0.3 mm to 15 mm have an aspect ratio of 1 or more. In an aspect of the process according to the invention the aspect ratio of the lingo-cellulose particles having a length in the range of from 0.3 mm to 15 mm is 2 or less.

In an embodiment of the process according to the invention the ligno-cellulose particles least partially covered with epicuticular wax include particles having a length in the range of from 10 mm to 500 mm, preferably in the range of from 10 mm to 300 mm, more preferably of from 10 mm to 250 mm, even more preferably of from 10 mm to 200 mm. Preferably at least 80%, based on the weight, of the ligno-cellulose particles at least partially covered with epicuticular wax have a length in the range of from 10 mm to 500 mm, preferably in the range of from 10 mm to 300 mm, more preferably of from 10 mm to 250 mm, even more preferably of from 10 mm to 200 mm. More preferably at least 95% based on the weight of the particles have a length in the range of from 10 mm to 500 mm, preferably in the range of from 10 mm to 300 mm, more preferably of from 10 mm to 250 mm, even more preferably of from 10 mm to 200 mm.

In an aspect of the process according to the invention the particles are a strand-like material.

The ligno-cellulose particles such as ligno-cellulose strands particularly suitable for making Oriented Strand Board (OSB) or Particle Board (PB) in the process according to the invention may have a length of preferably at least 5 mm, this being the average length of the strands as measured on a sample of at about 500 grams. If the strands have an average length of at least 5 mm, this contributes positively to the mechanical properties of the resulting panel. More preferably, the strands have an average length of at least 10, 15, 20, 25, 30, 40 or 50 mm. The upper value of the average length of the strands is primarily related to practical and origin-related constraints; thus, the said upper value can for example be up to 3000 mm, preferably up to 2000 mm, or preferably up to 1500, 1000, 750, 500, 400, 300, or 250 mm.

The thickness of the strands is, in particular for those of non-wood agricultural origin, primarily related to the thickness of the culture material itself. It is sometimes preferred to use split strands such as straw, the average thickness will then be a significant fraction of the original thickness, e.g. one-fifth, or even a quarter, one-third, or half thereof or more. Aside from this, it is preferred in view of the desired properties of the end panel that the strands have an average thickness of at least 0.1 mm, more preferably at least 0.2, 0.3, 0.4 or even 0.5 mm or more.

The width of the strands is, in particular for those of non-wood agricultural origin, primarily related to the width of the culture material itself.

In an embodiment of the process according to the invention 50% or more of the ligno-cellulose particles least partially covered with epicuticular wax are longitudinally split particles.

In an aspect of the invention the ligno-cellulose particles have a water content of 12% or less, this facilitates splitting. Splitting of the ligno-cellulose particles may be done prior to or after ozone treatment at a temperature of 30 degrees or more of the ligno-cellulose particles.

The splitting percentage may be determined visually by counting the number of lingo-cellulose particles which are split. For example if 100 particles are counted of which 50 are split particles, e.g. particles being in half, then 50% of the particles are split, i.e. 50% of the ligno-cellulose particles are longitudinally split particles. Preferably 60% or more of the ligno-cellulose particles are longitudinally split particles. Preferably 70% or more, 80% or more, 90% or more, 95% or more of the ligno-cellulose particles are longitudinally split particles.

The invention also relates to a process as described herein, wherein the ligno-cellulose particles least partially covered with epicuticular wax are in the form of strands, which have been oriented prior to step c).

An aspect of the invention relates to a process for the preparation of a panel comprising a strand-like straw material, comprising the following steps:
a) treating the strand-like straw with ozone at a temperature of at least 30 degrees Celsius;
b) mixing the resulting product with an water-based adhesive resin composition to obtain a resinated straw composition;
c) orienting the resinated straw composition;
d) pressing and at least partially curing the resinated straw strand composition obtained in step c) to obtain an oriented straw strand board panel.

In a preferred embodiment of the process according to the invention, in step a) the strand-like straw is treated with an ozone-containing gas having a temperature of at least 30 degrees Celsius.

The invention also relates to a panel, obtainable by a process as described herein.

The invention also relates to a panel, having the mechanical properties according to Canadian Standard CSA O437.0-93 Group 1 (R-1).

The invention also relates to an Oriented Strand Board, insulation board or Particle Board, obtainable by a process as described herein.

The invention also relates to a panel having mechanical properties according to European OSB standard EN 300.

The invention is also related to a panel. The panel according to the invention comprises ligno-cellulose particles selected from the group consisting of wheat straw particles, oat straw particles, rice straw particles, rye straw particles, barley straw particles and combinations thereof and an at least partially cured water-based adhesive resin composition.

In an aspect of the panel according to the invention the panel the ligno-cellulose particles consists of ligno-cellulose particles selected from the group consisting of wheat straw particles, oat straw particles, rice straw particles, rye straw particles, barley straw particles and combinations thereof and an at least partially cured water-based adhesive resin composition.

Preferably the panel according to the invention is a particle board (PB) panel or an Oriented Strand Board (OSB) panel.

The process for the production of an OSB is known in general, and described in for instance: “Holzwerkstoffe and Leime, M. Dunky and P. Niemz, p 133-135, Springer-Verlag, 2002” and in “Taschenbuch der Spanplatten Technik, Deppe & Ernst, p 258-266, 1991, DRW Verlag”. A strand board comprises strands, such strands may be oriented or not and may comprise multiple layers or a single layer.

An OSB having multiple oriented layers is typically prepared by first scattering—while usually achieving an orientation—the face layer strands, thereafter the core layer strands and then again a layer of face layer strands, followed by hot pressing this to an OSB. During the hot pressing curing of the adhesive composition takes place. The pressing can be continuous or batch wise. In the core layer and the face layers ligno cellulose strands of different length and orientation may be used. Typically, the strands in the face layers have smaller dimension(s) and less orientation than the ligno cellulose strands in the core layer.

Usually an OSB has three layers—a core and two face layers. It is also known that an OSB having 4 or more layers may be prepared, for instance by introducing at least one layer between the core and at least one face layer. Preferably within the context of the present invention, all layers that are not face layers are regarded—and treated according the invention—as core layer.

Typical known press conditions for OSB are 1-5 MPa, 180-230° C. during 3-20 sec/mm, preferably 4-12 sec/mm. As is known to those skilled in the art, press times are given in seconds per mm of OBS thickness.

The OSB panel according to the invention preferably comprises a core layer and two face layers, whereby at least one face layer comprises the water-based adhesive resin composition.

The OSB panel according to the inventions comprises at least one layer of ligno-cellulose strands at least partially covered with epicuticular wax combined with the water-based adhesive resin composition.

For particle board a pressure of 1-5 MPa is usually applied. The temperature at which the PB panel is pressed in a mould is generally 180-230° C. for particle board. For particle board a moulding time of 3-12 sec/mm, preferably 5-10 sec/mm is generally adopted, which moulding time is expressed in seconds per mm panel thickness.

One of the objectives of the invention is achieved in that a process is provided for the preparation of a panel that comprises the step of treating the ligno-cellulose particles, such as a strand-like straw particles with ozone at a temperature of at least 30 degrees Celsius.

In an embodiment of the panel according to the invention the water-based adhesive resin composition is selected from the group consisting of soy-based resins, protein based resins and aldehyde resins and wherein said aldehyde resins further comprise at least one component selected from the group consisting of urea, phenol and melamine and mixtures thereof.

In an embodiment of the panel according to the invention the ligno-cellulose particles include ligno-cellulose particles having a length of at least 0.3 mm. Preferably at least 80%, based on the weight, of the ligno-cellulose particles have a length of at least 0.3 mm.

In an embodiment of the panel according to the invention wherein the ligno-cellulose particles include ligno-cellulose particles having a length in the range of from 0.3 mm to 15 mm. Preferably at least 80%, based on the weight, of the lingo-cellulose particles have a length in the range of from 0.3 mm to 15 mm.

More preferably at least 95%, based on the weight, of the lingo-cellulose particles have a length in the range of from 0.3 mm to 15 mm.

In an embodiment of the panel according to the invention the ligno-cellulose particles include particles having a length in the range of from 10 mm to 500 mm, preferably a length in the range of from 10 mm to 300 mm, more preferably of from 10 mm to 200 mm, even more preferably of from 10 to 150 mm.

Preferably at least 80%, based on the weight, of the particles have a length in the range of from 10 mm to 500 mm, preferably a length in the range of from 10 mm to 300 mm, more preferably of from 10 mm to 200 mm, even more preferably of from 10 to 150 mm.

More preferably at least 95%, based on the weight, of the particles have a length in the range of from 10 mm to 500 mm, preferably a length in the range of from 10 mm to 300 mm, more preferably of from 10 mm to 200 mm, even more preferably of from 10 to 150 mm.

In an embodiment of the panel according to the invention the ligno-cellulose particles have the length in the range of from 10 mm to 500 mm, preferably the length in the range of from 10 mm to 300 mm, more preferably of from 10 mm to 200 mm, even more preferably of from 10 to 150 mm and furthermore 50% or more of such ligno-cellulose particles are longitudinally split particles. Preferably 60% or more of the ligno-cellulose particles are longitudinally split particles. Preferably 70% or more, 80% or more, 90% or more, 95% or more of the ligno-cellulose particles are longitudinally split particles.

The invention is further related to the use of the panels according to the invention and of the panels produced with the process according to the invention. The panels may be used in building and construction such as for example for construction of walls preferably bearing walls, for construction of floors, preferably bearing floors, for construction of ceilings or sheeting in a door. The panels may be used for example for concrete shuttering, for fencing an area or for producing boxes, containers or packaging material. Furthermore the panels according to the invention may be used in the manufacturing of furniture such as a table, a chair, a cupboard, a cabinet or a shelf.

The panel according to the invention may be laminated for example for decorative purposes. Lamination may for example be done by impregnating a paper optionally decorated with for example a print with an aminoplast resin to obtain impregnated paper and pressing the impregnated paper to the panel according to the invention. Suitable aminoplast resins are for example melamine-formaldehyde (MF) resin, melamine-urea-formaldehyde (MUF) resin, urea-formaldehyde (UF) resin. These resins, their preparation and their use for decorative applications such as laminates are known per se and described in for example 35 Kunststoff Handbuch, Vol. 10 Duroplaste (Becker, Braun; Carl Hanser Verlag 1988), where in Chapter 1.2.3 the preparation of melamine resins is described, and where in Chapter 4.4 the preparation of decorative laminates and laminated wood-based panels is described. The skilled person knows how to apply these techniques to the process and panel according to the invention.

The inventions also relates to furniture comprising the panel according to the invention.

The invention also related to a wall comprising the panel according to the invention.

The invention also relates to a floor comprising the panel according to the invention, preferably a bearing floor.

The invention also relates to the use of the panel according to the invention for concrete shuttering.

The invention also relates to a container comprising the panel to the invention.

In our co-pending application with application number PCT/EP2007/009560 which was filed before but published after the filing date of the present application, we describe the treatment of straw with UV and ozone for the preparation of particle boards. The present invention is novel over the former application in that the present treatment requires to treat the straw with ozone at a temperature of at least 30 degrees Celsius.

The term strand or strand-like material is used interchangeably herein to indicate a material with the shape of a strand, i.e. having a greater length than width. Preferably, the length is 2, 3, 4, 8, 20, 50, 100 or even more times the width. An optimal strand length for a given combination of strand-like material and resin can easily be determined experimentally by the skilled person.

The term ligno-cellulose is used herein to indicate any of several closely related substances constituting the essential part of woody cell walls of plants and consisting of cellulose intimately associated with lignin. The term more in particular relates to the combination of lignin, hemi cellulose and cellulose that forms the structural framework of plant cell walls. Ligno-cellulose is therefore the term used to refer to the bulk of plant material. It consists principally of lignin, cellulose, hemi cellulose and extractives. Woody biomass is about 45-50% cellulose, 20-25% hemi cellulose and 20-25% lignin.

The phrase ligno-cellulose containing strand-like material includes a strand mix comprising between 10 wt % and 100 wt % of non-wood agricultural strands. The term non-wood agricultural strands as used herein means strands from agriculturally grown plants or their harvested products/remnants, said plants reaching a harvest-stage of growth in two years or less. Such plants are as such widely known; examples of such plants or their harvested products include but are not limited to grass, straw, reed, (sugar) cane, bagasse, flax, hemp, kenaf, bamboo, cotton, cork, bark, sisal, and sorghum. As is known, the strands are typically not the entire original plant, but rather a part of it, typically the most fibrous part also know as rind. As is also known in the art, the strands may be obtained after some processing steps have been performed on the plants; said steps are not limited to but may include cutting, separating, and drying.

The process according to the invention may be applied using a wide variety of waterborne or water-based resins. Examples of such resins include soy-based resin as well as a resin composition comprising an aldehyde, and at least one component selected from the group consisting of urea, phenol and melamine, or mixtures thereof. A particularly suitable aldehyde may be formaldehyde.

In order to obtain a structurally solid board, the resin may preferably be cured. The skilled person will be aware of the different ways available for curing a particular type of resin.

The process according to the invention has the advantage that use is preferably made of non-wood agricultural strands, such as straw. These types of strands are renewable on a more frequent basis than wood—e.g. every two years, annually (annual crops) or even more frequent. At the same time, a panel can be prepared that has good mechanical properties and is suitable for most, if not all applications where wood-based panels are currently used. In frequent cases straw of a crop is treated as waste and experienced as an environmental problem. By making the panel according to the invention out of such straw this problem is reduced.

Within the context of this invention, the term panel is understood to mean a sheet that forms a distinct (usually flat) section or component of a material. Wood-based panels like chip board, MDF, Particle Board, or oriented strand board (OSB) are well known in the art. In a preferred embodiment of the invention, the method as described above relates to the preparation of a panel wherein the panel is an OSSB (oriented straw strand board).

The method according to the invention may be used for the preparation of a panel as described above, wherein the ligno-cellulose containing strand-like material comprises a mixture of different strands. This may mean that the ligno-cellulose containing strand-like material is heterogeneous with respect to source, length, strength, colour, stiffness or other relevant parameters. In particular, it may be derived from different sources, wherein straw is a preferred material. It is therefore possible that strands are used from more than one—e.g. 2, 3, 4 or even more—types of culture. Preferably, if there are strands from more than one origin, they are homogenously mixed.

The term straw is used herein to indicate the plant matter left over after the seeds are removed. More in particular, the term refers to the dry cut stalks of grain such as wheat, oat, rye, rice, barley etc. It may take the form of dried, hollow stems of grass plants with seed removed, usually left over after harvesting the plant material.

Since it is an objective of the present invention to enhance the use of quickly-renewable resources, the strands in the strand mix as used in the invention should contain at least 10 wt. % of non-wood agricultural particles, preferably strands. Preferably, the mix contains at least 20, 30, 40, 50, 60, 70, 80, or even 90 wt % or more of said non-wood agricultural strands. It is even possible that essentially all of the strands in the strand mix have non-wood agricultural origin.

In a process according to the invention, a particle mix preferably a strand mix may be treated with ozone at least 30 degrees Celsius. It has been found that this treatment leads to improved properties of the panel, such as a higher strength and better internal bonding in comparison with non-ozone treated straw or with ozone treated straw at room temperature (20 degrees Celsius), bonded together with water-based adhesive resin compositions. The treatment is thus effective to yield strand like material that can effectively be glued together using water-based resins. It has been established that such treatment is effective even when low dosages of ozone are applied. A dosage as low as 1 gram ozone per kg lingo-cellulose particles at least partially covered with epicuticular wax, preferably per kg straw particles. It is also found that it is important to perform the ozone treatment at elevated temperatures, since treatment with ozone at or below room temperature (20 degrees Celsius) does not result in sufficiently strong panels.

With elevated temperature herein and hereinafter is meant a temperature above 20 degrees Celsius, such as 25 degrees Celsius or more, 30 degrees Celsius or more, 40 degrees Celsius or more, 60 degrees Celsius or more, 80 degrees Celsius or more.

In order to apply the invention in an industrial setting, the ligno-cellulose particles, in particular ligno-cellulose strands may be placed on a conveyor belt in such a way that at least 5, 10 20 or 30 wt %, more preferably at least 40, 50, 60, or even at least 70 or 80 wt % of the ligno-cellulose particles, in particular ligno-cellulose strands are at least partly directly exposed to ozone. Alternatively, the treatment may take place in a conventional tumbler or other apparatus suitable for heating large quantities of material such as ligno-cellulose particles, in particular ligno-cellulose strand-like material.

As indicated above, in the experimental set up as chosen in the examples provided herein, ozone should be present when the ligno-cellulose particles, in particular ligno-cellulose strands are exposed to the elevated temperature. Preferably, the ozone concentration at and around the strands is between 0.1 and 30 vol %. Alternatively, the heat treatment of the ozone could take place at a different location and the ligno-cellulose particles, in particular ligno-cellulose strand-like material is then contacted with the reaction products of the heat treated ozone. Heat treatment of the ozone at a different location is termed herein treatment ex-situ.

Preferably, subsequent to the ozone treatment at an elevated temperature, the ligno-cellulose particles, in particular ligno-cellulose strands are brought together with the water-based adhesive resin composition. That may be done immediately or after some time. There were no effects measurable when the ozone treated ligno-cellulose particles, in particular straw particles were stored for a period of up to several days or even weeks.

Water-based adhesive resin compositions as such are known. In the invention, it is preferred to use an adhesive composition comprising a resin composition, whereby said resin composition contains an soy-based resin, protein based resin or an aldehyde based resin such as formaldehyde and at least one component selected from the group consisting of urea, phenol, melamine, melem, melam, ureidomelamine and mixtures thereof. Within the context of the invention, the mentioning of aldehydes, urea, phenol, melamine melem, melam and ureidomelamine refers to the compounds as such or in reacted form in resins or in water-based adhesive resin composition. Any molar ratios as given are for the accumulated amount, i.e. unreacted plus reacted compound.

As aldehyde in the resin composition, preferably formaldehyde is chosen. The term formaldehyde encompasses not only formaldehyde but also closely related compounds that can react as formaldehyde, such as paraformaldehyde and trioxan. Paraformaldehyde is a polymer or oligomer in the form of formaldehyde which splits of formaldehyde at depolymerisation. Paraformaldehyde with a polymerisation degree of n can generate n molecules of formaldehyde and thus formaldehyde equivalents. Formaldehyde may be partly or wholly replaced by another aldehyde such as methylglyoxylate methanol hemiacetal or another alkanol hemiacetal as listed on page 3 of WO 03/101973.

Suitable examples of the water-based adhesive resin composition which may be used in invention described herein without being limited thereto comprise: soy-based resin, Melamine-Urea-Formaldehyde (MUF) resin, Melamine-Formaldehyde (MF) resin, Urea-Formaldehyde (UF) resin, Phenol-Formaldehyde (PF) resin, Melamine-Phenol-Formaldehyde and/or Melamine-Urea-Phenol-Formaldehyde (MUPF) resin.

In the resin composition, the aldehyde has at least partly reacted with at least one of the group consisting of urea, an aromatic hydroxyl compound, and melamine. The molar ratios between these compounds can vary within wide limits. In order to discuss these limits, it is customary that the amounts of the amino compounds urea and melamine can be recalculated into —(NH₂)₂ equivalents, as this enables a calculation wherein the amounts of urea and melamine are combined into one number. It is preferred that the molar ratio between the aldehyde and the sum of —(NH₂)₂ and the aromatic hydroxyl compound lies between 1:0.2 and 1:2; more preferably, the said ratio lies between 1:0.3 and 1:1.8, or between 1:0.4 and 1:1.7, or between 1:0.5 and 1:1.6, or even between 1:0.6 and 1:1.5. When looking at the ratios between urea, melamine and the aromatic hydroxyl compound, it is noted that these ratios can vary in principle between all extremes, said extremes resulting in an melamine-aldehyde resin (urea and aromatic hydroxyl compound both essentially zero), an urea-aldehyde resin (melamine and aromatic hydroxyl compound both essentially zero), and an aromatic hydroxyl-aldehyde resin (melamine and urea both essentially zero).

The effect of the combined ozone/heat treatment was measured in an experimental set-up. As detailed in example 1, straw was heated and moisturised ozone was lead over the straw during a time varying between 1 and 20 minutes.

Straw thus treated was analysed for its ability to yield stronger panels. Therefore a model system was developed as detailed in Example 2. Therein the shear strength is measured of a straw glued to a wooden strip using a water-based adhesive resin composition.

On average, for each combination of time and temperature, ten pieces of straw were tested in the model system according to Example 2. The bond strengths were measured and if the average bond strength of the 10 experiments was 10N or below, the result was scored as a minus (−) in Table 1. If the average bond strengths was between 10N and 20N, the result was scored as plus/minus (+/−) and if the result was 20N or higher, the result was scored as a plus (+) in table 1.

The results (Table 1) show that there is a remarkable relationship between the temperatures applied and the shear force that a piece of straw can withstand before the water-based resin bond breaks.

As shown in Table 1, the shear strength obtained with untreated straw was in the order of 5 to 10 N. The straws that were treated with ozone at an elevated temperature such as a temperature above room temperature, such as 30 degrees Celsius or 40 degrees Celsius, already showed an average load of 15 N after 2 minutes and 20 N after 5 minutes of treatment. It was possible to treat the straw in such a way that it could withstand forces up to 80 N by applying a temperature of 145 degrees Celsius. Equally good results were obtained when straw was treated for longer times such as 20 minutes at a lower temperature such as 60 degrees Celsius. It is concluded that the average load increased of ozone treated straw with temperature and time in the experimental set-up (Table 1).

Panels were constructed from straw treated at 80 degrees Celsius for 10 minutes and from straw treated at 40 degrees for 20 minutes. Both materials resulted in good panels exceeding the minimum values for panel boards. (Table 2). An additional panel was constructed from straw treated with an ozone containing gas at 80 degrees Celsius for 2 min. Ozone was lead at 25 grams per cubic meter air through a glass tube containing water into the experimental set-up as shown in FIG. 1. Care was taken always to apply excess ozone. This was established by measuring the ozone concentration at the outlet of the glass tube. The ozone concentrations at the inlet were between 10 and 30 grams per cubic meter. Typically, the ozone concentrations at the outlet were 3 to 10 grams per cubic meter lower than at the inlet. As long as ozone was measurable at the outlet, it was concluded that excess ozone was applied to the process.

Control experiments performed at temperatures ranging from 20 to 145 degrees Celsius without any ozone treatment, did not result in any significant increase in bond strength of the straw.

It has to be mentioned here that not all data points measured in Example 1 represent the actual strength of the resin bond. Some straws broke even before the glued bond collapsed. These measurements were interpreted as representing the minimum strength of the bond. If the bond broke, this was interpreted as its maximum strength. Remarkably, In 11 out of 12 (92%) of the control experiments done at 20 degrees Celsius listed in table 1, the resin bond broke before the straw, indicating that the resin bond was much weaker than the straw itself. In contrast therewith, from the 350 straws that were treated with ozone at elevated temperatures, only 34 (10%) showed a break in the resin bond, whereas in all other cases, the straw broke before the resin bond collapsed. That means that the strength of the water-based resin bond in this case exceeded the strength of the straw, and thus yielded the straw suitable for use in a panel board. The strength of such an improved board would then only be determined by the strength of the particular kind of straw used for its production and not by the resin used.

It is also evident from the results shown in table 1 that the effect somewhat depends on the time of treatment.

Temperatures in these experiments varied between 20 degrees Celsius and 145 degrees Celsius. It is concluded that the effect can already be obtained when temperatures are used that are above room temperature (i.e. above 20 degrees Celsius), but in that case, the temperatures have to be applied somewhat longer (such as for 5 or 10 minutes) than in the case when a higher temperature is applied, such as 40 degrees or 60 degrees Celsius or higher. Care has to be taken that the temperature is not too high, i.e. at or above the flame temperature of the straw, in order not to destroy the straw in the process. Optimal conditions for a particular set-up may easily be determined experimentally by the skilled person.

When straw treated with ozone at elevated temperatures i.e. above 20 degrees Celsius, as described above, was used for the fabrication of boards, it was observed that any of the experimentally applied conditions was sufficient to yield better quality boards. This shows the validity of the experimental model as well as the industrial applicability of the present invention.

It will be appreciated that the conditions for applying the method according to the invention may vary over different ranges. It is now within the reach of the skilled person to determine the exact parameters under which improved straw panels may be produced. It is envisaged that a suitable process for producing ozone treated straw may use a conveyor belt that runs through a heating chamber where it is heated, or alternatively, a tumbler as is conventionally used in the industry.

Alternatively, the heating of ozone may take place in a separate compartment and the product may be fed into a chamber where the straw passes with a suitable speed. The equipment as described in example 2 may provide a useful tool to quickly determine whether a particular combination of features is effective in delivering the envisaged result.

It will also be understood that the process according to the invention may be useful for the production of all kinds of panels that require a superior mechanical strength. Such panels may include Oriented Strand Board, insulation board or Particle Board. The skilled person is aware of the meets and bounds of those types of panels.

In the way as described above, straw could be obtained that resulted in panel boards that had the mechanical properties according to Canadian Standard CSA 0437.0-93 Group1 (R-1).

It is noted that WO02/02288 discloses a method of manufacturing products which comprise fibrous lignocellulosic particles which are pressed and bonded into a layered, compressed structure. Examples of MDF fibre board manufacturing are described.

### SHORT DESCRIPTION OF THE FIGURES

FIG. 1: Schematic representation of an experimental setup used for the ozone treatment at elevated temperatures.

FIG. 2A. Longitudinal view of a schematic representation of an experimental setup for determining the shear strength of a bond of a water-based adhesive resin composition, also referred to herein as a water-based resin bond.

FIG. 2B Cross-sectional view of schematic representation of the set-up of FIG. 2A along line I-I. Legend: 101: wooden strip, 102: longitudinally split straw, 103; water-based resin bond. The character F indicates the forces in the directions of the arrows.

### DETAILED DESCRIPTION OF THE FIGURES AND EXAMPLES

### Example 1

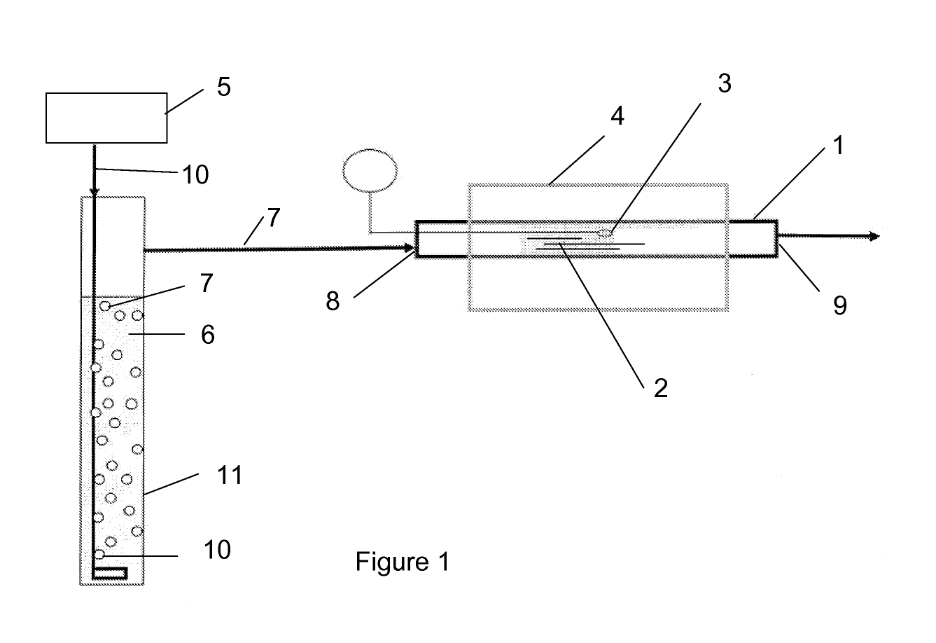

### Experimental Ozone Treatment (See FIG. 1)

Pieces of straw (North-American wheat straw) split in the longitudinal direction (2) essentially as described in European Patent EP 0998379B1 to Alberta Research Council were positioned in a glass tube (1). The individual straws had approximate dimensions of 5-20 cm length and a thickness as determined by the natural source. The glass tube (1) had a diameter of 17 mm and a length of 30 cm. The glass tube (1) was placed in an oven (4) at the required temperature and left there for 1 to 20 minutes (see table 1). Then the ozone was led through the tube. Temperature was measured using a chromel-alumel thermocouple (3).

An ozone inlet (8) was positioned in such a way that the ozone could flow freely and evenly distributed through the glass tube in the oven, along the straw, towards an ozone outlet (9) at the end of the glass tube (1).

Ozone-containing air (10) was generated from air using a commercially available ozone generator (5). Ozone thus generated was led through a water layer (6) in a glass tube (11) as shown in FIG. 1 to moisten the ozone. Experiments with dry ozone showed slightly less results and therefore it is preferred to use moistened ozone (7). Ozone flow was measured at the ozone-inlet (8) and the ozone-outlet (9) in order to determine the level of ozone consumption. 0.6 Gram straw (2) was put in the glass tube (1) and heated to the desired temperature while flowing the tube with moistened air. The air flow was adjusted to a predetermined level and the flow was measured. When the desired temperature was reached, the airflow through the tube was replaced by the preset ozone flow of 200 litre ozone-containing air during 2 minutes. The ozone concentration in the air was about 25 gram/litre. Ozone consumption was measured by determining the difference between ozone concentration at inlet (8) and outlet (9) using an ozone analyzer BMT964 from BMT Messtechnik Gmbh Germany. Special care was taken to ensure that enough ozone was available for the reaction. In practice this was done by ensuring that there was still ozone coming out of the outlet (9). About 275 gram of ozone was supplied per kg straw.

The ozone concentration may be measured using the method described in TechNote-TN-1 of BMT MESSTECHNIK Gmbh, Berlin, Rev. 03/2009 or in Ozone News, Volume 35, No. 1, January 2007, p. 20-26. An ozone generator type 503 from Fisher, Germany was used to generate an ozone containing gas. This ozone generator had a built in rotameter 0-500 NI/h from Vögtlin, Switserland to determine the amount of ozone supplied by the ozone generator.

### Example 2

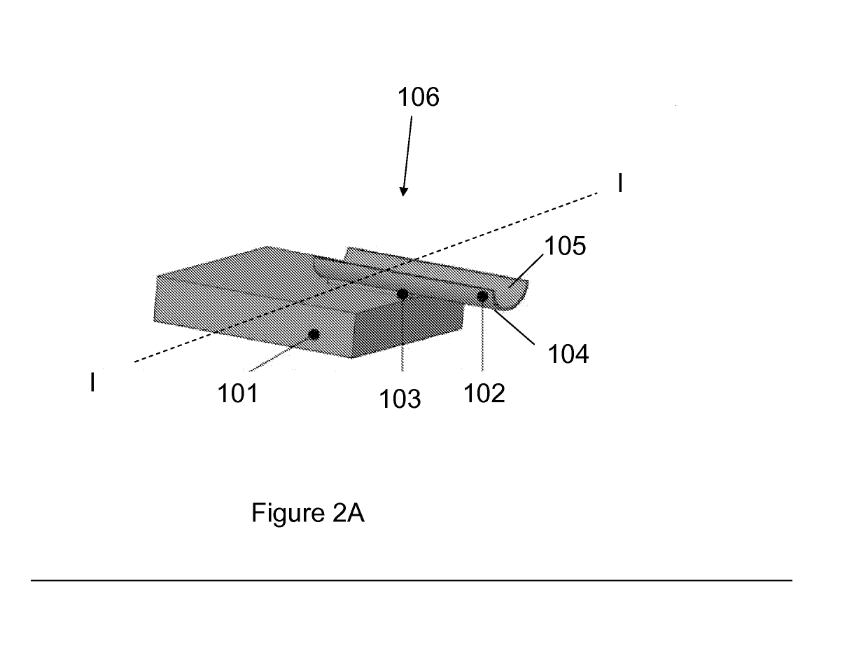

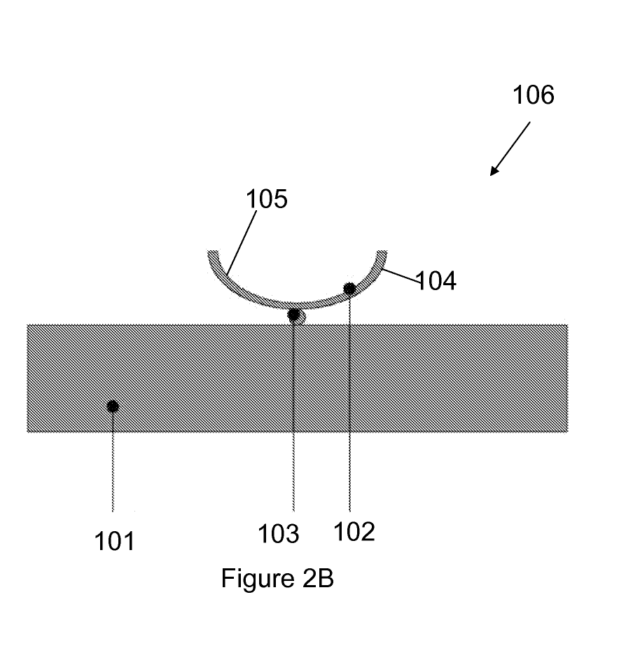

### Measuring of Shear Strength (See FIGS. 2a and 2b)

Longitudinally split North-American wheat straw (102) was treated in the way described in example 1, was recovered from the glass tube and glued to a wooden strip (101). Special care was taken to glue only the outside (104) of the straw to the wooden strip since it is known that the inside (105) provides a better bond with water-based resin (103) than the outside (FIGS. 2A and 2B). This effect is sometimes explained by the fact that the outside of straw contains a waxy or lipid layer whereas the inside does not. The water-based resin (103) used for gluing the straw to the wooden strip consisted of commercially available Melamine Urea Formaldehyde (MUF resin Hexion BR62WT). The glue was cured for about 1 minute at 140 degrees Celsius and the wooden strip with the straw attached (construct) (106) was then applied to an apparatus that measured the shear strength of the construct (106). The maximum load was determined in that an increasing force (F) was applied in the longitudinal direction of the construct. It was noted whether the straw broke or whether the bond collapsed. The results are shown in Table 1. In Table 1, a plus (+) sign indicates an average load of 20N or more, whereas a minus sign (−) indicates an average load of 10N or less (average over 10 experiments). A plus minus (+/−) indicates a result in between 10N and 20N.

The maximum load measurements were performed using an ABES apparatus supplied by AES. Inc., Corvallis, USA.

### Example 3

### Construction of Panel Boards

One to 14 cm long pieces of split wheat straw were treated for 10 and 20 minutes with ozone at a temperature of 80 and 40 degrees Celsius respectively, essentially as described in example 1. A commercially available MUF resin (Hexion BR62WT) containing ammonium sulphate as a catalyst was sprayed onto the straw using an atomiser in an amount of 8-10 dry wt %. A mat of dimensions 865×865 mm was constructed by hand and pressed at 190 degrees Celsius at a controlled pressure of 1700 KPa during 160-200 seconds. The panels were pressed to the target thickness of 11.1 mm.

After pressing, the panels were trimmed to dimensions of 711×711×11.1 mm. The density was 640 kg/m3; the various plates obtained according to the above procedure showed densities ranging from 624 to 675 g/m₃.

### Example 4

### Performance of OSB Made from Ozone Treated Straw

Two separate panels (panel 1 and panel 2) produced according to example 3 were tested for their strength according to Canadian Standard CSA O437/Group 1 (R-1). A prior art board was constructed in exactly the same way as described in example 3, without the ozone treatment and is shown for comparative purposes (comparative panel I). Modus of elasticity (MOE) and Modus of Rupture (MOR) of the panels according to the invention were measured in this experiment as well as the internal bond strength of the panels.

The results are shown in Table 2.

In an additional experiment a third panel (panel 3) was produced according to example 3. Split wheat straw (split for about 95%) was treated with ozone at a temperature at 80 degrees Celsius for 2 minutes. For the ozone treatment 10.5 m³/hour ozone-containing air having an ozone concentration of 18.5 gram ozone/m³ was used. The MOE and MOR of panel 3 exceeded the required minimum value according to Canadian standard CSA O437/Group 1 (R-1). Panel 3 had an Internal Bonding of 0.415 MPa.

TABLE 1

| | Temp [Degrees Celcius] | | | | | | | |
|---|---|---|---|---|---|---|---|---|
| Time [min] | 20 | 40 | 55 | 60 | 80 | 100 | 125 | 145 |
| 20 | − | + | + | + | + | + | + | + |
| 10 | − | + | + | + | + | + | + | + |
| 5 | − | + | + | + | + | + | + | + |
| 2 | − | +/− | +/− | + | + | + | + | + |
| 1 | − | − | +/− | +/− | +/− | +/− | + | + |

TABLE 2
OSB panel properties

| | Static Bonding | | Internal |
|---|---|---|---|
| | MOE | | Bonding |
| | [MPa] | MOR [MPa] | [MPa] |
| Required minimum value according | 3100 | 17.2 | 0.345 |
| to Canadian standard CSA | | | |
| O437/Group 1 (R-1). | | | |
| Comparative panel I¹⁾ No ozone | <500 | <5 | <0.05 |
| treatment | | | |
| Panel 1¹⁾ treated at 55 degrees | 3900 | 29.4 | 0.378 |
| Celsius for 20 minutes | | | |
| Panel 2¹⁾ treated at 30 degrees | 3300 | 21.1 | 0.359 |
| Celsius for 10 minutes | | | |
| Comparative panel II²⁾ treating at 55 | <1000 | <10 | <0.10 |
| degrees for 20 minutes | | | |
| Comparative panel III¹⁾ treating at 55 | <500 | <5 | <0.05 |
| degrees for 20 minutes, no glue | | | |

¹⁾straw split for about 95%
²⁾straw split for about 30%

1. Process for the preparation of a panel comprising ligno-cellulose particles, comprising the following steps:
a) treating ligno-cellulose particles at least partially covered with epicuticular wax with ozone at a temperature of at least 30 degrees Celsius;
b) mixing the resulting product with an water-based adhesive resin composition to obtain a resinated particle composition;
c) pressing and at least partially curing the resinated particle composition obtained in step b) to obtain a panel.

2. Process according to claim 1, wherein the ligno-cellulose particles least partially covered with epicuticular wax comprise Poaceae particles, preferably grass particles.

3. Process according to claim wherein the ligno-cellulose particles least partially covered with epicuticular wax comprise particles selected from the group consisting of wheat straw particles, oat straw particles, rice straw particles, rye straw particles and barley straw particles and combinations thereof.

4. Process according to claim 1, wherein prior to step b) the ligno cellulose particles at least partially covered with epicuticular wax are mixed with wood particles.

5. Process according to claim 1, wherein the water-based adhesive resin composition is selected from the group consisting of soy-based resin, protein based resin, an aldehyde resin, with the aldehyde resin further comprising at least one component selected from the group consisting of urea, phenol, melamine, melem, melam and ureido melamine and mixtures thereof.

6. Process according to claim 5, wherein the aldehyde is selected from the group consisting of formaldehyde, glyoxal and acetaldehyde and combinations thereof.

7. Process according to claim 1, wherein the ligno-cellulose particles least partially covered with epicuticular wax include ligno-cellulose particles having a length of at least 0.3 mm.

8. Process according to claim 1, the ligno-cellulose particles least partially covered with epicuticular wax include ligno-cellulose particles having a length in the range of from 0.3 mm to 15 mm.

9. Process according to claim 1, wherein the ligno-cellulose particles least partially covered with epicuticular wax include ligno-cellulose particles having a length in the range of from 10 mm to 500 mm.

10. Process according to claim 9, wherein 50% or more of the ligno-cellulose particles least partially covered with epicuticular wax are longitudinally split particles.

11. Process according to claim 1, wherein the ligno-cellulose particles least partially covered with epicuticular wax are in the form of strands, which have been oriented prior to step c).

12. Panel comprising ligno-cellulose particles selected from the group consisting of wheat straw particles, oat straw particles, rice straw particles, rye straw particles, barley straw particles and combinations thereof and an at least partially cured water-based adhesive resin composition.

13. Panel according to claim 12, wherein the water-based adhesive resin composition is selected from the group consisting of soy-based resins, protein based resins and aldehyde resins and wherein said aldehyde resins further comprise at least one component selected from the group consisting of urea, phenol and melamine and mixtures thereof.

14. Panel according to claim 12, wherein the ligno-cellulose particles include ligno-cellulose particles having a length of at least 0.3 mm.

15. Panel according to claim 14, wherein the ligno-cellulose particles include ligno-cellulose particles having a length in the range of from 0.3 mm to 15 mm.

16. Panel according to claim 14, wherein the ligno-cellulose particles include ligno-cellulose particles having a length in the range of from 10 mm to 500 mm.

17. Panel according to claim 16, wherein 50% or more of the particles are longitudinally split particles.

18. A wall comprising a panel according to claim 12.

19. A floor comprising a panel according to claim 12.

20. Use of the panel according to claim 12, for concrete shuttering.

21. A container comprising a panel according to claim 12.
